(19) United States
(12) Patent Application Publication
(10) Pub. No.: US 2022/0270017 A1
(43) Pub. Date: Aug. 25, 2022

(54) RETAIL ANALYTICS PLATFORM

(71) Applicant: CAPILLARY PTE. LTD., Singapore (SG)

(72) Inventors: Biswa Gourav Singh, Bengaluru (IN); Pranoot Prakash Hatwar, Nagpur (IN); Rishabh Ojha, Bengaluru (IN); Saurav Kumar Behera, Bengaluru (IN); Subrat Kumar Panda, Bengaluru (IN); Rohan Mahadar, Bengaluru (IN); Aneesh Reddy, Bengaluru (IN)

(21) Appl. No.: 17/677,099

(22) Filed: Feb. 22, 2022

(30) Foreign Application Priority Data
Feb. 22, 2021 (IN) 202141007369

(51) Int. Cl. G06Q 10/06; G10L 25/78; G10L 17/02; G10L 17/04; G10L 17/06; G10L 21/0208; G10L 25/51

(52) U.S. Cl. CPC G06Q 10/06393; G10L 25/78; G10L 17/02; G10L 17/04; G10L 17/06; G10L 21/0208; G10L 25/51

(57) ABSTRACT

A retail analytics platform is provided. The retail analytics platform is adapted for use in a retail store includes a speech analysis module configured to process audio files to determine a plurality of attributes. The speech analysis module comprises a voice activity detection (VAD) module, a speaker recognition module and an insights module configured to determine a plurality of performance metrics for the retail store based on the plurality of attributes.

### PRIORITY STATEMENT

The present application claims priority under 35 U.S.C. § 119 to Indian patent application number 202141007369 filed Feb. 22, 2021, the entire contents of which are hereby incorporated herein by reference.

### BACKGROUND

The invention relates generally to retail analytics and more particularly to a speech analytics platform for use in the retail stores.

In the last decade, the e-commerce sector has grown exponentially and systems are being deployed to maximize customer experience. Detailed analysis is usually performed on each customer's buying patterns and profile data to get insights into the each customer's retail habits. However, it is often very difficult to implement such systems in a regular physical store.

In physical stores, one way to gather the customer's data is to capture user interaction with the store staff. However, the user interaction for the each customer is varied and difficult to capture for multiple reasons, such as a level of noise in the store, a language used by a customer etc. More particularly, in physical stores it is often hard to track the store staff and determine whether a store protocol is being followed as desired. Another challenge is to identify if the each customer is engaged properly by the store staff. For example, it is a challenge to determine if a customer's queries are being properly addressed and if the customer is satisfied with the answers that have been provided by the store staff.

It is also difficult for store staff to pitch products and brands to a customer in a physical store. In e-commerce websites this is easily done by presenting various options to the customer as he/she continues shopping. However, the same techniques are difficult to implement within a physical store. Considering the above challenges it is often very difficult to get an insight about a particular product or a brand, a product demand, feedback about the product, views about a competitor product etc.

Therefore, there is a need for a robust technique for determining each customer's experience as he/she visits a physical store so as to enable a seamless customer experience. Also, there is a need for collecting customer data as this will assist the store with their sales and revenue management and provide a deeper insight of the products and brands that are sold by the store.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a retail analytics platform is provided. The retail analytics platform adapted for use in a retail store comprises one or more audio devices configured to capture audio data representative of a plurality of interactions. Each interaction is between at least one customer and at least one staff member. The retail analytics platform further includes a speech analysis module coupled to the one or more audio devices configured to process each audio file to determine a plurality of attributes. The speech analysis module comprises a voice activity detection (VAD) module configured to detect a plurality of silent portions and a plurality of speech portions in each audio file. The speech analysis module further includes a speaker recognition module configured to identify a plurality of boundaries within the audio file, wherein each boundary represents a transition point between two or more speakers, generate a plurality of clusters. Each cluster comprises audio data belonging to a speaker each cluster is classified as either customer or staff member. The retail analytics platform includes an insights module coupled to the speech analysis module and configured to determine a plurality of performance metrics for the retail store based on the plurality of attributes.

In another embodiment, a method for analyzing a plurality of audio files is provided. The method comprises receiving one or more audio files, wherein the one or more audio files comprise audio data representative of a plurality of interactions; wherein each interaction is between at least one customer and at least one staff member. The method comprises analysing each audio file to determine a plurality of attributes by detecting and removing one or more silent portions in the audio file; identifying a plurality of boundaries within the audio file, wherein each boundary represents a transition point between two or more speakers; wherein the speaker is either the customer or the staff member, generating a plurality of clusters; wherein each cluster comprises audio data belonging to a specific speaker, classifying each cluster as either customer or staff member and deriving a plurality of insights by determining a plurality of performance metrics for the retail store based on the plurality of attributes.

In another embodiment, a speech analysis system for identifying a plurality of speakers from an audio file is provided. The speech analysis module comprises a voice activity detection (VAD) module configured to receive the audio file; wherein the audio file comprises a plurality of silent portions and a plurality of speech portions. The VAD is configured to detect the plurality silent portions and remove the plurality of silent portions from the audio file and detect the plurality of speech portions and to apply a time stamp on the plurality of speech portions in the audio files. The speech analysis module further comprises a speaker recognition module configured to identify a plurality of boundaries within the audio file, wherein each boundary represents a transition point between a first speaker and a second speaker, generate a plurality of clusters; wherein each cluster comprises audio data belonging to the first speaker or the second speaker, classify each cluster as either first speaker or second speaker and tag the plurality of speech portions as either of the first speaker or the second speaker.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating one embodiment of retail analytics platform, implemented according to the aspects of the present technique;

FIG. 2 is a flow chart illustrating a manner in which the audio files are analysed; according to aspects of the present technique;

FIG. 3 is a block diagram illustrating one embodiment of a speech analysis system implemented according to aspects of the present technique; and

FIG. 4 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

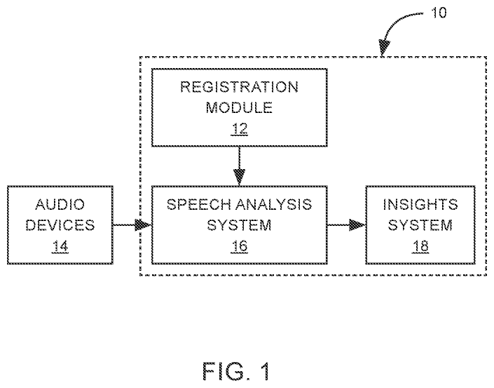

Turning to the drawings, FIG. 1 is a block diagram illustrating one embodiment of retail analytics platform, implemented according to the aspects of the present technique. The retail analytics platform 10 includes audio devices 14, a speech analysis system 16 and an insights module 18. Each component is described in further detail below.

Registration module 12 is configured to store voice signatures of the staff members. In one embodiment, a staff member is enrolled into the retail analytics platform by requesting to vocalise one or more phrases from a set of predefined phrases which are recorded. Voice features are extracted from the audio recording to form a unique voice signature for each staff member.

Audio devices 14 are configured to capture audio data representative of a plurality of interactions occurring within the retail store and stored as an audio file. Each interaction is between at least one customer and at least one staff member. In one embodiment, the audio devices are disposed in multiple locations within the retail store. In another embodiment, the audio devices are wearable devices worn by the staff members employed in the retail store.

Speech analysis system 16 is configured to receive one or more audio files from the audio devices 14. Speech analysis system 16 is configured to analyze the audio content of the audio files representing the interactions between the customers visiting the store and the staff members. In one embodiment, the speech analysis system 16 is configured to identify the staff members from the audio file by identifying the staff member's unique voice signature accessed from the registration module.

In one embodiment, the speech analysis system 16 is implemented using artificial intelligence (AI) models. In a further embodiment, speech and natural language processing (NLP) based machine learning techniques are used to analyze the received audio files. The audio files are analyzed to determine various aspects to the retail store such as to identify sentiments, identify gender profiles, determine product category and attributes, etc.

Insight system 18 is configured to derive insights from the analyzed audio files provided by the speech analysis system 16. Insights include key performance indicators for sales, marketing, customer satisfaction, etc. which will enhance the revenues of the retail store. In one embodiment, the insights are presented to management personnel in the retail store in the form of a dashboard. The dashboard is an interactive user interface which enables the management to simulate various scenarios based on the customer interactions with the store staff

In one embodiment, the dashboard is configured to track a plurality of metrics such as non-compliance indicators of store staff based on interactions with customer, sales over time by reducing customer churn and insight about product demand. Further the dashboard is configured to track customer metrics such as net promoter score (NPS), customer satisfaction, customer effort, customer retention, etc. The dashboard may also be used to provide a dynamic solution for store staff recognition and enrollment of a new staff in the store. All the above insights are derived from the audio files corresponding to interactions between a customer and a staff member. The manner in which the audio files are analyzed are described in further detail below.

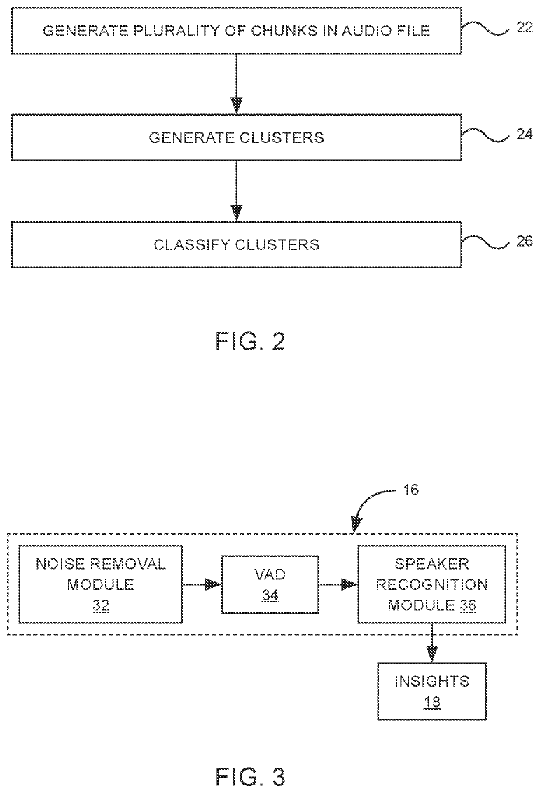

FIG. 2 is a flow chart illustrating a manner in which the audio files are analyzed. As used herein, speaker is either a customer or a staff member. The process begins upon receiving an audio file that contains audio data representative of several customer interactions. Each step of the process is described in further detail below.

In step 22, the audio file is segmented into a plurality of chunks by identifying a plurality of boundaries within the audio file. In one embodiment, each boundary represents a transition point between two or more speakers. Each chunk comprises audio data from a speaker. It may be note that the speaker is either the customer or the staff member. For example, if the audio file comprises an interaction between a single customer and two staff members, three chunks are generated for each speaker.

In step 24, a plurality of clusters are generated, wherein each cluster comprises chunks belonging to a specific speaker. In one embodiment, clustering based techniques are used for identifying similar chunks together.

In step 26, each cluster is classified as either the customer or the staff member. In one embodiment, clusters belonging to the staff member is identified by comparing with the voice signatures captured by the registration module. In one embodiment, when a chunk closest to the any staff member's voice signature is identified, all the other chunks in the cluster is tagged with the same staff member. The steps described above are implemented using a speech analysis system 16 which is described in further detail below.

FIG. 3 is a block diagram of one embodiment of a speech analysis system 16 implemented according to aspects of the present technique. The speech analysis system 16 is configured to analyse audio files to determine a plurality of attributes. Examples of attributes include one or more attributes comprises one or more sentiments, gender profile, category of products, product identifiers, and the like. The speech analysis system 16 comprises noise removal module 32, VAD 34 and speaker recognition module 36. Each block is described in further detail below.

Noise removal module 32 is configured to remove noise components from the audio files received from audio devices 14. Examples of noise components include background music, telephone ringtones, and the like. Noise removal module conditions the audio files by removing the noise components and enhancing the speech components within the audio file. In one embodiment, the noise removal module uses a deep learning based a priori SNR estimation for speech enhancement.

Voice activity detection (VAD) module 34 is configured receive the enhanced audio file from the noise removal module. The enhanced audio file includes a plurality of silent portions and a plurality of speech portions in each audio file. As used herein, the silent portions refer to portions within the audio file that do not have any speech content. Upon detection of the silent portions, the VAD module 34 is configured to remove the silent portions from the audio file. Further, the VAD module 34 is configured to apply a time stamp on the plurality of speech portions in the audio files. A time stamp is an indicative of the time and date when the interaction occurred.

Speaker recognition module 36 is configured to identify a plurality of boundaries within the audio file. In one embodiment, each boundary represents a transition point between two or more speakers. The speaker generation module 36 is configured to generate a plurality of clusters; wherein each cluster comprises audio data belonging to a specific speaker. In the example described herein, the speaker is a customer or a staff member. Each cluster is then tagged as with either the customer or the staff member.

In one embodiment, deep learning text-independent speaker verification algorithms are used for identifying the portion of speech which contains the staff member's voice. Further, the audio clips belonging to the staff member or the customer is chunked and feature embeddings are created for each chunk. The embedding generated contains data representing conversations between the store staff and the customer and is used to derive insights regarding the products, the store or the staff member, amongst other things.

Thus, the VAD module 34 generates time stamps in the audio file where speech exists, and the speaker recognition model 36 generates time stamps mapped to information regarding the speaker in a specific chunk (either store staff or customer). Thus, a mapping of time stamps with speech and respective speaker identity can be easily generated. In one embodiment, the mapping for time stamps and their respective embeddings are stored in a database.

In one embodiment, the speaker recognition module 36 is configured to transcribe each audio file into corresponding text file. In one embodiment, the transcription is implemented by applying an automatic speech recognition (ASR) model. The ASR model is trained using a plurality of voice samples representative of a plurality of languages and a plurality of accents.

In one embodiment, the speaker recognition module 36 is configured to use deep learning based natural language processing algorithms on the text file to obtain product attribute keywords and speaker sentiment. It may be noted that the speaker recognition model is retrainable and is updated periodically while onboarding new staff members. In a further embodiment, the speech recognition module 36 is configured to add and update dictionaries that are specific to an organization or a business.

The above described techniques provide several advantages including determining several performance metrics of the staff members in the store. Similarly, several keywords appearing the interactions can be used to determine the quality of the service of the staff members in the store.

The systems and methods described herein may be partially or fully implemented by a special purpose computer system created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium, such that when run on a computing device, cause the computing device to perform any one of the aforementioned methods. The medium also includes, alone or in combination with the program instructions, data files, data structures, and the like. Non-limiting examples of the non-transitory computer-readable medium include, but are not limited to, rewriteable non-volatile memory devices (including, for example, flash memory devices, erasable programmable read-only memory devices, or a mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Program instructions include both machine codes, such as produced by a compiler, and higher-level codes that may be executed by the computer using an interpreter. The described hardware devices may be configured to execute one or more software modules to perform the operations of the above-described example embodiments of the description, or vice versa.

Non-limiting examples of computing devices include a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to the execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

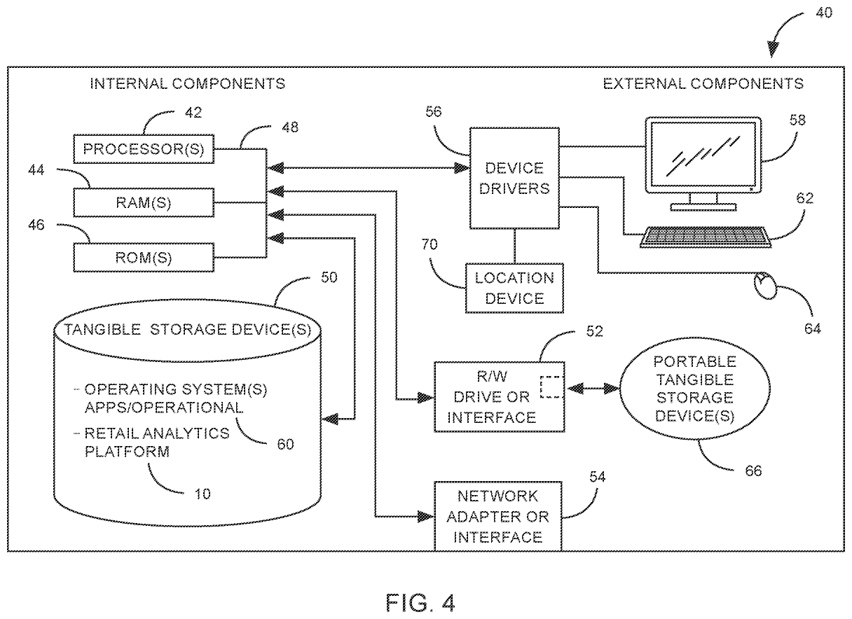

One example of a computing system 40 is described below in FIG. 4. The computing system 40 includes one or more processor 42, one or more computer-readable RAMs 44 and one or more computer-readable ROMs 46 on one or more buses 48. Further, the computer system 48 includes a tangible storage device 50 that may be used to execute operating systems 60 and product comparison system 100. Both, the operating system 60 and the product comparison system 100 are executed by processor 42 via one or more respective RAMs 43 (which typically includes cache memory). The execution of the operating system 60 and/or product comparison system 100 by the processor 42, configures the processor 42 as a special-purpose processor configured to carry out the functionalities of the operation system 60 and/or the product comparison system 100, as described above.

Examples of storage devices 50 include semiconductor storage devices such as ROM 503, EPROM, flash memory or any other computer-readable tangible storage device that may store a computer program and digital information.

Computing system 40 also includes a R/W drive or interface 52 to read from and write to one or more portable computer-readable tangible storage devices 66 such as a CD-ROM, DVD, memory stick or semiconductor storage device. Further, network adapters or interfaces 54 such as a TCP/IP adapter cards, wireless Wi-Fi interface cards, or 3G or 3G wireless interface cards or other wired or wireless communication links are also included in the computing system 40.

In one example embodiment, the retail analytics platform may be stored in tangible storage device 50 and may be downloaded from an external computer via a network (for example, the Internet, a local area network, or another wide area network) and network adapter or interface 54.

Computing system 40 further includes device drivers 56 to interface with input and output devices. The input and output devices may include a computer display monitor 58, a keyboard 62, a keypad, a touch screen, a computer mouse 64, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

1. A retail analytics platform adapted for use in a retail store, the retail analytics platform comprising:
one or more audio devices configured to capture audio data representative of a plurality of interactions; wherein each interaction is between at least one customer and at least one staff member;
a speech analysis module coupled to the one or more audio devices configured to process each audio file to determine a plurality of attributes; wherein the speech analysis module comprises:
a voice activity detection (VAD) module configured to detect a plurality of silent portions and a plurality of speech portions in the each audio file; and
a speaker recognition module configured to identify a plurality of boundaries within the each audio file, wherein each boundary represents a transition point between two or more speakers; generate a plurality of clusters; wherein each cluster comprises audio data belonging to a speaker; and classify each cluster as either customer or staff member; and
an insights module coupled to the speech analysis module and configured to determine a plurality of performance metrics for the retail store based on the plurality of attributes.

2. The retail analytics platform of claim 1, wherein the VAD module is configured to detect the plurality silent portions and remove the plurality of silent portions from the each audio file.

3. The retail analytics platform of claim 1, wherein the VAD module is configured detect the plurality of speech portions and to apply a time stamp on the plurality of speech portions in the each audio file.

4. The retail analytics platform of claim 3, wherein the speaker recognition module is further configured to tag the plurality of speech portions with either the customer or the staff member.

5. The retail analytics platform of claim 1, wherein the speaker recognition module is further configured to transcribe the each audio file into corresponding text file by applying an automatic speech recognition (ASR) model; wherein the ASR model is trained using a plurality of voice samples representative of a plurality of languages and a plurality of accents.

6. The retail analytics platform of claim 1, further comprising a registration module configured to register each staff member; wherein the each staff member is registered with a corresponding voice signature.

7. The retail analytics platform of claim 6, wherein speaker recognition module is configured to tag the each staff member by matching each cluster with the corresponding voice signature registered in the registration module.

8. The retail analytics platform of claim 1, wherein the one or more attributes comprises one or more sentiments, gender profile, category of products and product identifiers.

9. The retail analytics platform of claim 1, wherein the speech analysis module further comprises a noise removal module configured to remove noise components and enhance speech components present in the plurality of audio files.

10. The retail analytics platform of claim 1, wherein at least one audio device is placed at a predetermined location within the retail store to capture the plurality of interactions between the plurality of customers and staff members.

11. A method for analyzing a plurality of audio files, the method comprising receiving one or more audio files, wherein the one or more audio files comprise audio data representative of a plurality of interactions; wherein each interaction is between at least one customer and at least one staff member;
processing each audio file to determine a plurality of attributes by:
detecting and removing one or more silent portions in the each audio file;
generate a plurality of chunks by identifying a plurality of boundaries within the each audio file, wherein each boundary represents a transition point between two or more speakers and each chunk comprises audio data from a speaker; wherein the speaker is either a customer or a staff member
generating a plurality of clusters; wherein each cluster comprises chunks belonging to a specific speaker; and
classifying each cluster as either the customer or the staff member;
deriving a plurality of insights by determining a plurality of performance metrics for the retail store based on the plurality of attributes.

12. The method of claim 11, further comprising:
detecting a plurality of silent portions in the each audio file;
applying a time stamp on a plurality of speech portions; and
tagging the plurality of speech portions with either the customer or the staff member.

13. The method of claim 11, further comprising transcribing the each audio file into a corresponding text file by applying an automatic speech recognition (ASR) model.

14. The method of claim 13, further comprising training the ASR model using a plurality of voice samples representative of a plurality of languages and a plurality of accents.

15. The method of claim 11, further comprising storing sample audio data corresponding to each staff member.

16. The method of claim 11, further comprising removing noise components and enhancing speech components present in the plurality of audio files.

17. A speech analysis system for identifying a plurality of speakers from an audio file, wherein the speech analysis module comprises:
a voice activity detection (VAD) module configured to receive the audio file; wherein the audio file comprises a plurality of silent portions and a plurality of speech portions; and wherein the VAD is configured to:
detect the plurality silent portions and remove the plurality of silent portions from the audio file; and
detect the plurality of speech portions and to apply a time stamp on the plurality of speech portions in the audio files.
a speaker recognition module configured to:
identify a plurality of boundaries within the audio file, wherein each boundary represents a transition point between a first speaker and a second speaker;
generate a plurality of clusters; wherein each cluster comprises audio data belonging to the first speaker or the second speaker;
classify each cluster as either the first speaker or the second speaker; and
tag the plurality of speech portions as either the first speaker or the second speaker.

18. The speech analysis system of claim 17; wherein the speaker recognition module is further configured to transcribe each audio file into a corresponding text file by applying an automatic speech recognition (ASR) model; wherein the ASR model is trained using a plurality of voice samples representative of a plurality of languages and a plurality of accents.

19. The speech analysis system of claim 18; further comprising a voice library configured to continuously update and store the plurality of voice samples; wherein the plurality of voice samples is collected from a plurality of sources.

20. The speech analysis system of claim 17; further comprising a noise removal module configured to remove noise components and enhance speech components present in the plurality of audio files.
